(19) United States
(12) Patent Application Publication
(10) Pub. No.: US 2013/0025999 A1
(43) Pub. Date: Jan. 31, 2013

(54) METHOD FOR OPERATING AN AUTOMATED CLUTCH

(71) Applicant: Schaeffler Technologies AG & CO. KG, Herzogenaurach (DE)

(72) Inventors: Michael Schindler, Buehl (DE); Juergen Eich, Buehl (DE); Juergen Gerhart, Appenweier (DE)

(73) Assignee: Schaeffler Technologies AG & CO. KG, Herzogenaurach (DE)

(21) Appl. No.: 13/630,352

(22) Filed: Sep. 28, 2012

Related U.S. Application Data
(63) Continuation of application No. PCT/DE2011/000296, filed on Mar. 21, 2011.

(30) Foreign Application Priority Data
Apr. 8, 2010 (DE) 102010014201.8

(51) Int. Cl. F16D 25/12

(52) U.S. Cl. 192/85.63

(57) ABSTRACT

The invention relates to a method for operating an automated clutch of a motor vehicle, which is operated using a hydrostatic actuator of a hydraulic clutch operating system, which includes a slave cylinder and a master cylinder that contain hydraulic medium, a volume equalization of the hydraulic medium being carried out in a driving operation in order to counteract a detuning of the clutch operating system. The invention is distinguished by the fact that the volume equalization is carried out as needed during operation of the clutch depending on current clutch characteristic values, if the driving comfort is not, or not inappropriately, diminished.

### CROSS-REFERENCE TO RELATED APPLICATIONS

This application is filed under 35 U.S.C. §120 and §365(c) as a continuation of International Patent Application No. PCT/DE2011/000296, filed Mar. 21, 2011, which application claims priority from German Patent Application No. 10 2010 014 201.8, filed Apr. 8, 2010, which applications are incorporated herein by reference in their entirety.

### FIELD OF THE INVENTION

The invention relates to a method for operating an automated clutch of a motor vehicle, which is operated using a hydrostatic actuator of a hydraulic clutch operating system, which includes a slave cylinder and a master cylinder that contain hydraulic medium, a volume equalization of the hydraulic medium being carried out in a driving operation in order to counteract a detuning of the clutch operating system.

### BACKGROUND OF THE INVENTION

From German patent application DE 10 2008 057 656 A1 a clutch system having a master cylinder and a slave cylinder is known, which has a connecting aperture that connects the master cylinder to a readjustment container for pressure medium, while signals dependent on the rotational speed of a friction clutch are obtained and issued to the actuator.

### BRIEF SUMMARY OF THE INVENTION

The object of the invention is to improve a method according to the preamble of claim 1 in order to increase driving comfort. The object is based on an automated clutch of a motor vehicle, which is operated using a hydrostatic actuator of a hydraulic clutch operating system. This clutch operating system includes a slave cylinder and a master cylinder which contain hydraulic medium, a volume equalization of the hydraulic medium being carried out in a driving operation in order to counteract a detuning of the clutch operating system.

The object is fulfilled by carrying out the volume equalization as needed during operation of the clutch depending on current clutch characteristic values, if the driving comfort is not, or not inappropriately, diminished. That enables the time period between periodically executed volume equalization processes to be prolonged. It is also possible to no longer carry out the volume equalization periodically, but only as needed. By evaluating the current clutch characteristic values or clutch characteristic data, the demand for volume equalization processes can be adjusted to the actual need. An interval for the volume equalization of the hydrostatic link of the clutch actuator is determined dynamically. That makes it possible to clearly reduce conflicts between equalization processes and driving comfort.

A preferred exemplary embodiment of the method is characterized in that the volume equalization is carried out during operation of the clutch depending on shifts in touch points. A touch point describes a defined actuator position at which the clutch assigned to the actuator transmits a specified torque, for example, three Newton meters. When a touch point changes, a characteristic curve of the clutch is shifted in parallel. The touch point may be ascertained, for example, using an evaluation of transmission input speeds during a suitable clutch operation.

Another preferred exemplary embodiment of the method is characterized in that a touch point of the clutch adapted during driving operation is evaluated. Assuming a well-functioning touch point adaptation during driving operation, the volume equalization serves primarily to preserve the functionality of the clutch operating system. At the same time there must be assurance that, on the one hand, the clutch separates reliably, and, on the other hand, is able to transmit the required clutch torque.

Another preferred exemplary embodiment of the method is characterized in that short-term and long-term adaptive values for the touch point are used. While it is true that a volume equalization is a necessary and actively sought process, in principle it also results in a shifting (back) of the clutch characteristic curve. Through the use of short-term and long-term adaptive values for the touch point, a measure can be provided for correcting this (back) shifting.

Another preferred exemplary embodiment of the method is characterized in that the volume equalization is carried out during operation of the clutch if the adapted touch point clearly changes during driving operation. If the value of the adapted touch point changes only very little during driving operation, it can be assumed that the hydraulic transmission link has not changed, and that there is also therefore no need for a volume equalization. The demand for and execution of the next volume equalization can then be delayed without problem.

Another preferred exemplary embodiment of the method is characterized in that the volume equalization is carried out during operation of the clutch depending on temperature information. The temperature information is used in order to determine an expected volume change in the clutch operating system.

Another preferred exemplary embodiment of the method is characterized in that the temperature information is obtained with the help of temperature sensors. With the help of the temperature sensors, it is possible, for example, to obtain a clutch bell temperature, a clutch actuator temperature, an engine coolant temperature, an engine chamber temperature and/or a transmission oil temperature.

Another preferred exemplary embodiment of the method is characterized in that the temperature information is obtained from temperature models. In this case it is possible to use both temperature models of the clutch and temperature models of the clutch operating system, which is also referred to as the clutch disengaging system.

Another preferred exemplary embodiment of the method is characterized in that the volume equalization is carried out during operation of the clutch if the temperature is changed by a defined minimum amount. The defined minimum amount can be obtained through experiments.

Another preferred exemplary embodiment of the method is characterized in that the volume equalization is carried out during operation of the clutch if the volume change of the hydraulic medium determined in a computed model on the basis of temperature influences exceeds a defined minimum amount. The defined minimum amount can be obtained through experiments.

### DETAILED DESCRIPTION OF THE INVENTION

The clutch is preferably a dual clutch or a dual clutch system having two partial clutches. The clutch, in particular a dual clutch, is preferably operated directly by the hydrostatic actuator, i.e., without intervention of lever machines.

Additional advantages, features and details of the invention derive from the following description, in which various exemplary embodiments are described in detail.

The invention relates to a clutch operating system, as described for example in the German patent application DE 10 2008 057 656 A1. The clutch operating system includes a clutch, in particular an automated friction clutch, which is preferably designed as a dual clutch. The clutch is operated using a hydraulic clutch operating system, which includes a master cylinder and a slave cylinder that are connected to each other by means of a hydraulic line, also referred to as a pressure line. The master cylinder has a connecting aperture which connects the master cylinder to a readjustment container for hydraulic medium, when a master cylinder piston assumes a certain position in the master cylinder. The master cylinder piston is operated hydrostatically, using an actuator which is controlled by a control device.

With hydrostatically actuated clutch actuators there must be assurance that the hydraulic link, which includes the master cylinder and the slave cylinder, is always balanced to a sufficient degree. Various influences, for example, temperature influences, can result in changes in the volume of the hydraulic medium. These volume changes result in a detuning of the hydraulic system, i.e., a resulting position on the clutch shifts in an undesired manner.

In order to counteract this shifting, a defined position of the master cylinder is traversed, so that the connecting aperture to the equalization container is opened. Through the connecting aperture the hydraulic medium can be released into the readjustment container, which is also referred to as a readjustment chamber.

In the case of a pressure-engaged dual clutch, the volume equalization is carried out by disengaging the clutch completely.

According to an essential aspect of the invention, a logic system is provided which recognizes and possibly compensates for a shift in the clutch characteristic curve on the basis of touch point shifts and/or while making allowance for temperature signals. This enables the frequency of the volume equalization to be reduced, and in particular the volume equalization can only be carried out if no unwanted effects on the driving comfort can be expected.

According to one aspect of the invention, the touch point of the clutch adapted during driving operation is evaluated. If its value changes only very little during driving operation, it can be assumed that the hydraulic transmission link has not changed, and that there is also therefore no need for a volume equalization. The demand for and execution of the next volume equalization can then be delayed without problem.

According to another aspect of the invention, temperature information is drawn upon alternatively or in addition in order to determine an expected volume change in the clutch operating system. Volume equalization is required, for example, if the temperature has changed by a defined minimum amount since the last volume equalization. Alternatively, a volume equalization can be required if the volume change determined in a computed model on the basis of temperature influences exceeds a defined minimum amount.

The temperature information can come either from temperature sensors or can be obtained from temperature models of the clutch and/or its operating system. With the help of the temperature sensors, it is possible, for example, to determine a clutch bell temperature, a clutch actuator temperature, an engine coolant temperature, an engine chamber temperature and/or a transmission oil temperature. The named solutions may also be combined.

What we claim is:

1. A method for operating an automated clutch of a motor vehicle, which is operated using a hydrostatic actuator of a hydraulic clutch operating system that includes a slave cylinder and a master cylinder which contains hydraulic medium, where in a driving operation a volume equalization of the hydraulic medium is carried out in order to counteract a detuning of the clutch operating system, characterized in that the volume equalization is carried out as required during operation of the clutch depending on current clutch characteristic values, if the driving comfort is not, or not inappropriately, diminished.

2. The method according to claim 1, characterized in that the volume equalization is carried out during operation of the clutch depending on shifts in touch points.

3. The method according to claim 2, characterized in that a touch point of the clutch adapted during driving operation is evaluated.

4. The method according to claim 3, characterized in that short-term and long-term adaptive values for the touch point are used.

5. The method according claim 2, characterized in that the volume equalization is carried out during operation of the clutch if the adapted touch point clearly changes during driving operation.

6. The method according to claim 1, characterized in that the volume equalization is carried out during operation of the clutch depending on temperature information and/or pressure information.

7. The method according to claim 6, characterized in that the temperature information is obtained with the help of temperature sensors.

8. The method according to claim 6, characterized in that the temperature information is obtained from temperature models.

9. The method according to claim 6, characterized in that the volume equalization is carried out during operation of the clutch if the temperature is changed by a defined minimum amount.

10. The method according to claim 6, characterized in that the volume equalization is carried out during operation of the clutch if the volume change of the hydraulic medium determined in a computed model on the basis of temperature influences exceeds a defined minimum amount.
